(19) United States
(12) Patent Application Publication
(10) Pub. No.: US 2014/0316844 A1
(43) Pub. Date: Oct. 23, 2014

(54) MESSAGING ENGINE

(71) Applicant: Nipendo Ltd., Netanya (IL)

(72) Inventors: Alon ROSENBERG, Kfar Saba (IL); Eyal ROSENBERG, Kfar Saba (IL)

(73) Assignee: Nipendo Ltd., Netanya (IL)

(21) Appl. No.: 14/201,873

(22) Filed: Mar. 9, 2014

Related U.S. Application Data
(60) Provisional application No. 61/814,353, filed on Apr. 22, 2013.

(51) Int. Cl. G06Q 10/06

(52) U.S. Cl. CPC G06Q 10/0633
USPC 705/7.27

(57) ABSTRACT

A supply chain management system comprising: a system server comprising a central processor and a database; a plurality of user computers communicating with the system server over a network; the system server running a software process defining: an interface layer configured to communicate messages and business transactions bi-directionally between the user computers and the system server; and a services layer configured to apply business logic to the messages and business transaction and process them according to a predefined workflow of the supply chain management system, the services layer comprising a messaging engine module configured to send and receive messages triggered by the business transactions, the messages composed according to predefined system rules.

### FIELD OF THE INVENTION

The present invention is in the field of computerized supply chain management systems and pertains more particularly to messaging mechanisms within these systems.

### BACKGROUND

Supply chain management is considered nowadays as one of the most prominent subjects in the Information Technology (IT) domain and is characterized by the fastest growth rate in the Enterprise IT domain and with many technological developments.

A supply chain management system is a software platform for electronic connectivity between businesses (B2B). The platform enables the creation of a cooperative electronic commerce community for clients, suppliers and business partners, for performing all the supply-chain related activities automatically and electronically.

### SUMMARY

According to a first aspect of the present invention there is provided a supply chain management system comprising: a system server comprising a central processor and a database; a plurality of user computers communicating with the system server over a network; said system server running a software process defining: an interface layer configured to communicate messages and business transactions bi-directionally between said user computers and said system server; and a services layer configured to apply business logic to said messages and business transaction and process them according to a predefined workflow of said supply chain management system, said services layer comprising a messaging engine module configured to send and receive messages triggered by said business transactions according to predefined system rules.

The predefined system rules may be stored in said database and the system may further be configured to override at least part of said rules with user defined rules.

The rules may comprise medium selection rules for determining a message medium of transmittance according to predefined criteria.

The medium may be selected from the group consisting of: email, SMS and Instant Messaging application and the predefined criteria may comprise message type.

The rules may comprise formatting rules for determining a message format according to predefined criteria and the predefined criteria may comprise a selected transmittance medium.

The rules may comprise localization rules for determining a message language according to predefined criteria.

The rules may comprise scheduling rules for determining a message transmittance schedule according to predefined criteria and the predefined criteria may be selected from the group consisting of: transmit as early as possible, aggregate messages and send at predefined times and aggregate up to a predefined number of messages.

The rules may comprise priority rules for determining a message transmittance priority and the priority rules may selected from the group consisting of: message content, sender, recipient, length and creation time.

The messaging service may further comprise an automatic message creation mechanism.

A message may comprise a category and the service may further comprise an automatic routing mechanism configured to route said message according to said message category.

According to a second aspect of the present invention there is provided a method performed by a software process executed on a supply chain management system comprising a system server comprising a central processor and a database and a plurality of user computers communicating with the system server over a network, the software process comprising: communicating business transactions bi-directionally between said user computers and said system server; applying business logic to said business transaction and processing them according to a predefined workflow of said supply chain management system; and sending and receiving messages triggered by said business transactions, according to predefined system rules.

According to a third aspect of the present invention there is provided a non-transitory computer-readable medium encoding instructions that, when executed by data processing apparatus, cause the data processing apparatus to perform operations comprising: communicating business transactions bi-directionally between said user computers and said system server; applying business logic to said business transaction and processing them according to a predefined workflow of said supply chain management system; and sending and receiving messages triggered by said business transactions, according to predefined system rules.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic functional representation of a supply chain management system;

FIG. 2 is a schematic functional representation of the interface layer according to some embodiments;

FIG. 3 is a schematic functional representation of the services layer according to some embodiments;

FIG. 4 is schematic representation of the functional modules invoked by the process manager and their inter-relations;

FIG. 5 is a schematic representation of the messaging service connectivity according to some embodiments; and

FIG. 6 is a schematic representation of the messaging service according to some embodiments.

### DETAILED DESCRIPTION OF PREFERRED EMBODIMENTS

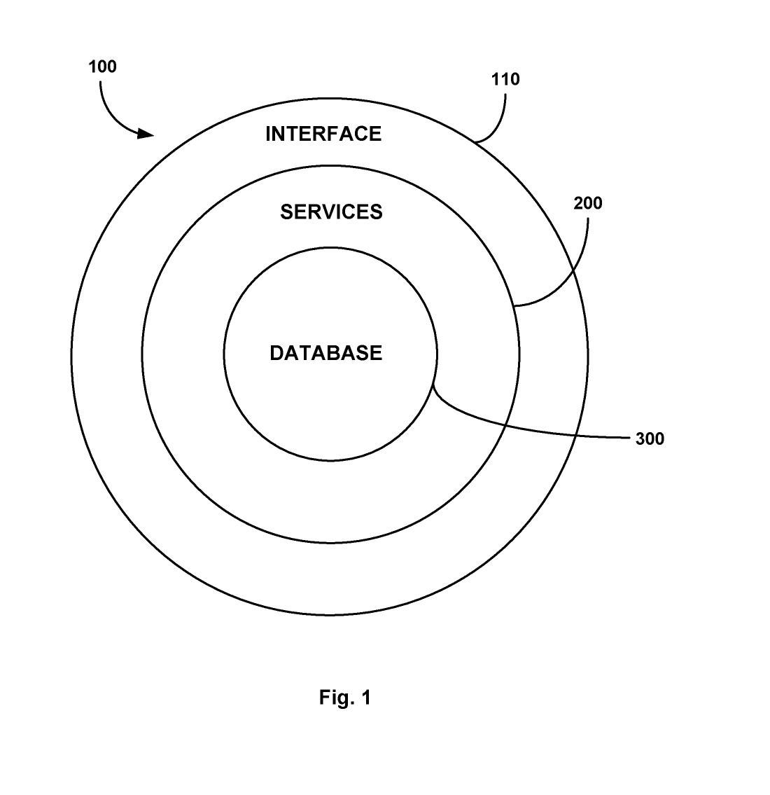

FIG. 1 is a schematic functional representation of a supply chain management system 100. The system 100 is transaction-motivated, where a transaction may be any business related document (e.g. purchase order, invoice, etc.) provided to the system by one of its users (e.g. client) and intended for another system user (e.g. supplier).

The system 100 comprises three main functional layers which interact with each other to provide the required capabilities: interface layer 110, services layer 200 and database 300.

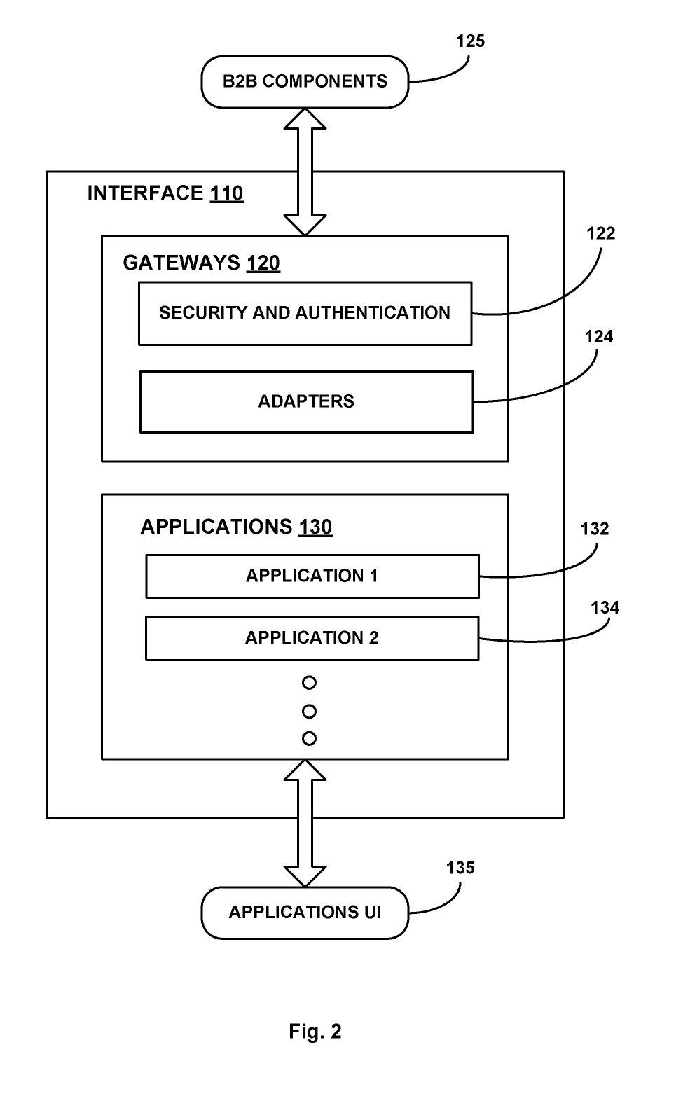

FIG. 2 is a schematic functional representation of the interface layer 110, which connects the system 100 with its users for inputting messages and transactions into the system and receiving messages and transactions from the system. Several modes of communication may be supported. For example, the system may communicate directly with B2B components 125 comprising, for example, modules of the user's ERP system. Transactions received from B2B components may be directed by the system to various gateways 120, such as, for example, RosettaNet, CXML and EDI, for security and authentication checks 122 and for conversion of the transaction in the B2B component format into a common system data format (e.g. XML) by a suitable adapter 124.

An additional or alternative mode of communication between the system and the users may be provided, namely direct interaction mode, where the user is provided with user interfaces (UI) 135 to various applications 130, enabling her to enter transaction data into the system and receive data from the system. The applications may be provided as web services or as client applications communicating with a server application. The applications may allow operations such as, for example, database searches, reports creation, transactions creation (e.g. create an invoice from an order), etc.

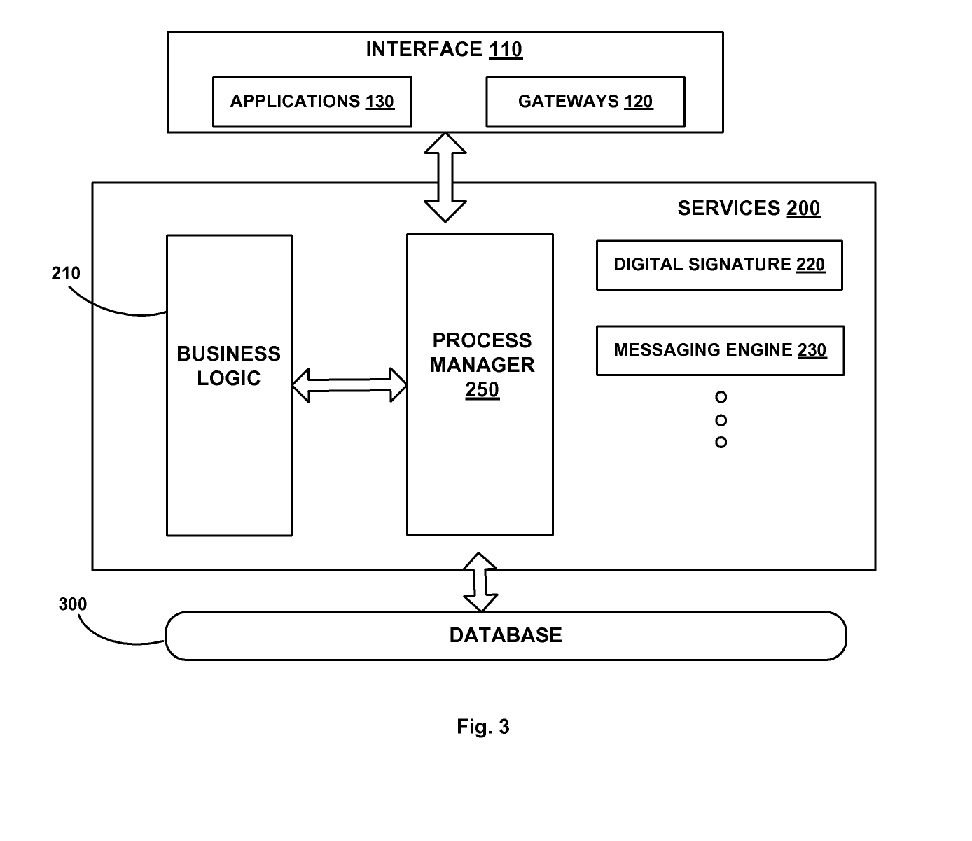

FIG. 3 is a schematic functional representation of the services layer 200, which mediates between the interface layer 110 and the database 300 to enable the various system operations. At the core of service layer 200 are the process manager 250 and the business logic module 210.

Process manager 250 is in charge of receiving B2B transactions and messages from the gateways 120 and managing the business process by invoking the appropriate services 200 in the right order, as will be explained in detail in conjunction with FIG. 3.

Business logic module 210 separates business logic from other system modules. It receives requests from the applications 130 and handles them according to request type. For example, business logic module 210 may create a transaction such as a new invoice as a result of user activity in an application and pass it on to the process manager 250 for further handling. In another example, the business logic module 210 may receive a request for a report via an application, e.g. show all the open orders of a user, which it may handle internally in compliance with a predefined set of permissions, etc.

Database 300 stores transactions and messages. Transactions may be stored in any suitable format for further processing such as XML or a proprietary format. Database 300 may additionally store transaction (e.g. invoices) images in a format such as PDF.

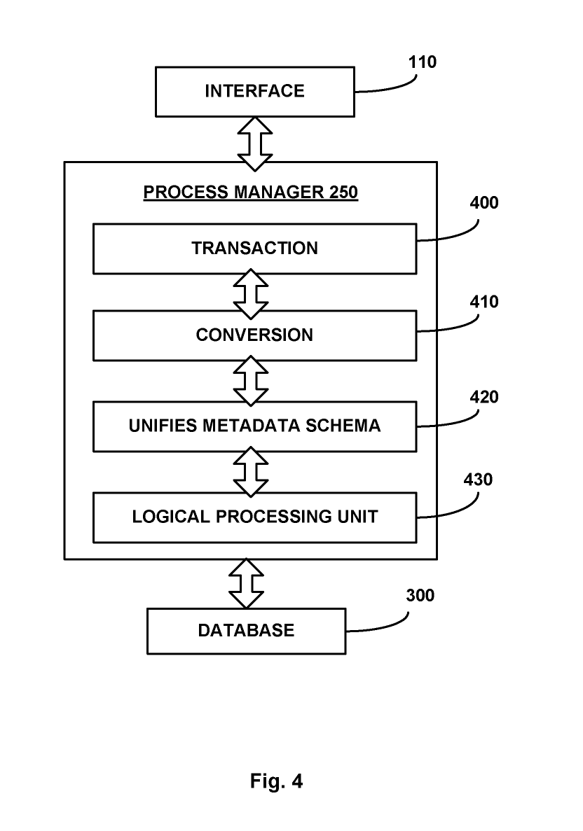

FIG. 4 is schematic representation of the functional modules invoked by the process manager 250 and their inter-relations. Transaction module 400 receives a transaction from the interface layer 110, saves it in the database and transfers it to the conversion module 410 for conversion from e.g. native XML to a proprietary internal format (UMS 420). The conversion process includes translation of the data structure and contents, completing missing data or correcting data according to pre-stored business logic data (e.g. in the order line the Total Line Quantity may be missing and the conversion process can calculate this information and derive it from the Quantity and Unit Price fields) and storing in database 300.

The processed transaction is passed on to the logical processing unit (LPU) which identifies the relevant business event, e.g. new order, invoice status or warehouse receipt, etc., the transaction source and destination and its place in the business process as defined for the sender and recipient in the business logic module 210.

The LPU may put a transaction on hold, e.g. in wait for additional event, or initiate a process in response, e.g. sending a received purchase order to the supplier. The initiated process gets the transaction from the database 300 and transfers it to the interface layer 110 for delivery to its destination in the appropriate format.

According to embodiments of the present invention, the supply chain management system 100 comprises a central messaging service 230 that handles all messages intended for the system users, which may be automatically initiated by a business event or a status change (e.g. warnings, reminders), or messages from users wishing to update another user or group of users with information pertaining to a business process such as discussions or questions and answers regarding orders or invoices. Messaging service 230 is responsible for receiving and distributing messages in real time.

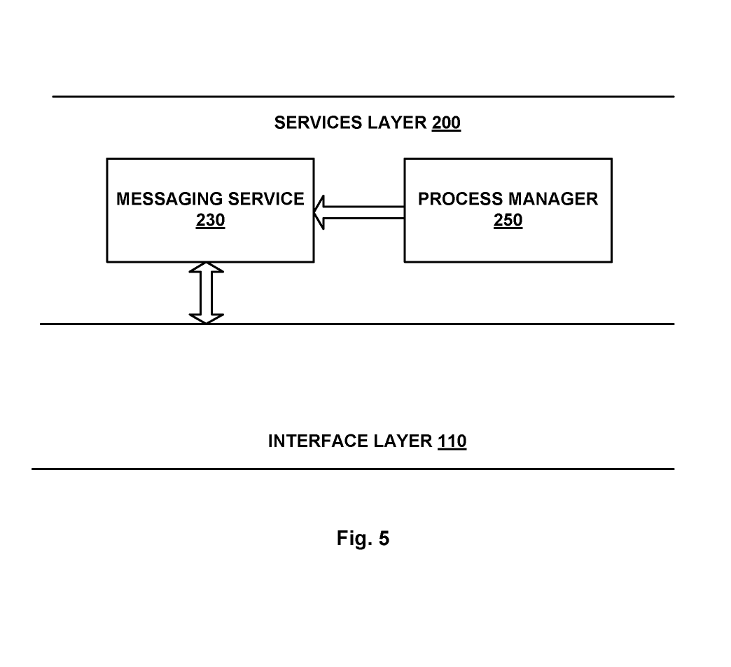

FIG. 5 is a schematic representation of the messaging service 230 connectivity according to embodiments of the present invention. Messaging service 230 is connected with the interface layer 110, for receiving messages from users and sending messages to user and with the process manager module 250 for receiving messages triggered by business events or transactions.

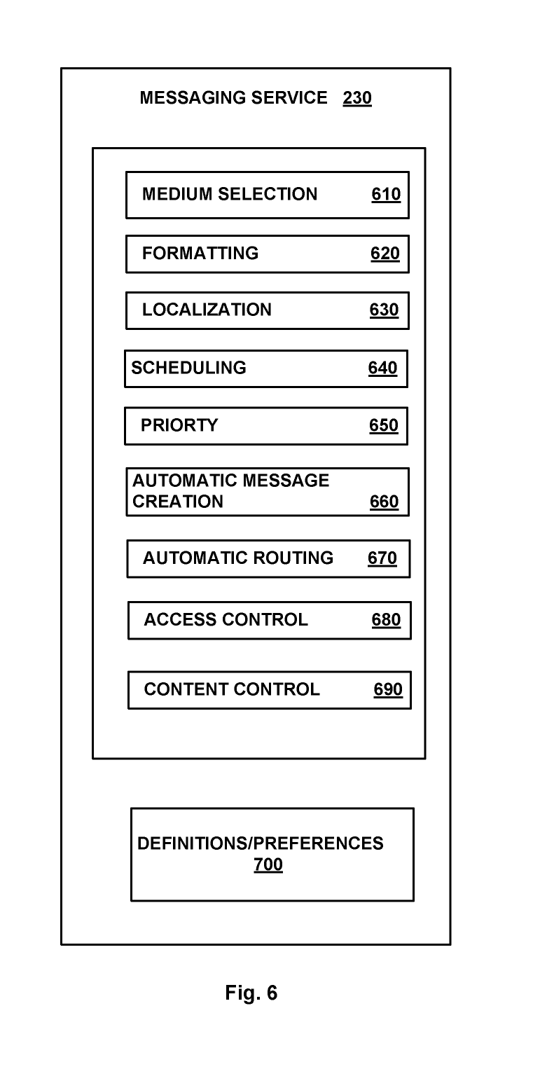

According to embodiments of the present invention, as schematically depicted in FIG. 6, the messaging service 230 comprises a plurality of modules, for example:

Medium selection 610

Formatting 620

Localization 630

Scheduling 640

Priority 650

Automatic message creation 660

Automatic routing 670

Access control 680

Content control 690.

Messaging service 230 may additionally comprise a definitions and preferences repository 700 used by the various modules to perform automatic message related operations, as will be explained in detail below. Repository 700 may comprise system definitions or rules and user definitions and/or preferences, which may be created at registration time or at any time thereafter and may override system rules.

### Medium Selection Module 610

A message may be sent to a user in a variety of delivery media, e.g. email, SMS, Instant Messaging application such as Facebook or WhatsApp, or an internet portal provided with the a system application 130. Medium selection module 610 selects the medium to be used per message. The medium selection may be based on user or system preferences/rules stored in repository 700, or automatically determined by the medium selection module.

### Formatting 620

A message may be sent to a user in a variety of formats, which may depend on the selected delivery medium. For example, a message sent via email may contain graphics, advertisement, etc. Formatting module 620 may select the message format automatically, based on the selected medium, or may format the message according to user (recipient) preferences stored in repository 700.

### Localization 630

A message may be sent to a user in a variety of languages. The localization module 630 selects the message language according to user (recipient) preferences stored in repository 700. A default language may be defined in the system. Pre-translated standard messages or message parts may be stored and assembled in real time to compose a message.

### Scheduling 640

Messages may be sent by the system according to a time schedule defined by the receiving user. A user may wish to receive each message at the earliest possible time. Alternatively, a user may wish for the system to aggregate messages sent to her and send them at predefined times, or once a day, or every X messages, etc.

Since the system operates worldwide the scheduler should consider the local time of the recipient and schedule messages accordingly.

### Priority 650

The messaging service may comprise a priority scheme for sending messages to users. Priority may be based on message content, sender, recipient, message length, creation time, etc.

### Automatic Message Creation 660

The messaging service may automatically create messages and initiate their sending. For example, if a message requiring confirmation within a predefined time frame has been sent, the messaging service may monitor the confirmation receipt and initiate a reminder message if confirmation is not received within the predefined time frame.

### Automatic Routing 670

Messages may be divided into categories predefined in the system and the sender may provide the message category. This enables the messaging service to automatically route a message to a specific person in the organization according to the message category. For example, questions related to orders will be routed to the procurement manager; request for new connections will be routed to the business specialist, customer may want to broadcast message to all its vendors' account receivable without knowing exactly the user list of the appropriate account receivable in all of its vendors etc.

### Access Control 680

The system may have several configurations defining different usage permission. For example, a usage level may allow using the system but prevent the user from receiving notifications. The access control module 680 checks the requested operation vis-à-vis the permissions and acts accordingly.

### Content Control 690

Different users may have different permissions to view documents, depending on the document's content. For example, a supplier may have permission to view purchase orders except for purchase orders by a certain user. The content control module 690 checks the requested operation vis-à-vis the permissions and acts accordingly.

The subject matter described herein can be implemented as one or more computer program products, i.e., one or more computer programs tangibly embodied in non-transitory media, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

At least some of the subject matter described herein may be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other in a logical sense and typically interact through a communication network. The relationship of client and server may arise by virtue of computer programs running on the respective computers and having a client-server relationship to each other.

A number of embodiments have been described. Nevertheless, it will be understood that various modifications may be made without departing from the spirit and scope of the invention. Accordingly, other embodiments are within the scope of the following claims.

1. A supply chain management system comprising:
a system server comprising a central processor and a database;
a plurality of user computers communicating with the system server over a network;
said system server running a software process defining:
an interface layer configured to communicate messages and business transactions bi-directionally between said user computers and said system server; and
a services layer configured to apply business logic to said messages and business transaction and process them according to a predefined workflow of said supply chain management system,
said services layer comprising a messaging engine module configured to send and receive messages triggered by said business transactions according to predefined system rules.

2. The system of claim 1, wherein said predefined system rules are stored in said database, the system further configured to override at least part of said rules with user defined rules.

3. The system of claim 1, wherein said rules comprise medium selection rules for determining a message medium of transmittance according to predefined criteria.

4. The system of claim 3, wherein said medium is selected from the group consisting of: email, SMS and Instant Messaging application.

5. The system of claim 3, wherein said predefined criteria comprise message type.

6. The system of claim 1, wherein said rules comprise formatting rules for determining a message format according to predefined criteria.

7. The system of claim 6, wherein said predefined criteria comprise a selected transmittance medium.

8. The system of claim 1, wherein said rules comprise localization rules for determining a message language according to predefined criteria.

9. The system of claim 1, wherein said rules comprise scheduling rules for determining a message transmittance schedule according to predefined criteria.

10. The system of claim 9, wherein said predefined criteria are selected from the group consisting of: transmit as early as possible, aggregate messages and send at predefined times and aggregate up to a predefined number of messages.

11. The system of claim 1, wherein said rules comprise priority rules for determining a message transmittance priority.

12. The system of claim 11, wherein said priority rules are selected from the group consisting of: message content, sender, recipient, length and creation time.

13. The system of claim 1, wherein said messaging service further comprises an automatic message creation mechanism.

14. The system of claim 1, wherein a message may comprise a category, the service further comprising an automatic routing mechanism configured to route said message according to said message category.

15. A method performed by a software process executed on a supply chain management system comprising a system server comprising a central processor and a database and a plurality of user computers communicating with the system server over a network, the software process comprising:
communicating business transactions bi-directionally between said user computers and said system server;
applying business logic to said business transaction and processing them according to a predefined workflow of said supply chain management system; and
sending and receiving messages triggered by said business transactions, according to predefined system rules.

16. The method of claim 15, wherein said predefined system rules are stored in said database, further comprising overriding at least part of said rules with user defined rules.

17. The method of claim 15, wherein said rules comprise medium selection rules for determining a message medium of transmittance according to predefined criteria.

18. The method of claim 17, wherein said medium is selected from the group consisting of: email, SMS and Instant Messaging application.

19. The method of claim 17, wherein said predefined criteria comprise message type.

20. The method of claim 15, wherein said rules comprise formatting rules for determining a message format according to predefined criteria.

21. The method of claim 20, wherein said predefined criteria comprise a selected transmittance medium.

22. The method of claim 15, wherein said rules comprise localization rules for determining a message language according to predefined criteria.

23. The method of claim 15, wherein said rules comprise scheduling rules for determining a message transmittance schedule according to predefined criteria.

24. The method of claim 23, wherein said predefined criteria are selected from the group consisting of: transmit as early as possible, aggregate messages and send at predefined times and aggregate up to a predefined number of messages.

25. The method of claim 15, wherein said rules comprise priority rules for determining a message transmittance priority.

26. The method of claim 25, wherein said priority rules are selected from the group consisting of: message content, sender, recipient, length and creation time.

27. The method of claim 15, further comprising automatically creating messages.

28. The method of claim 15, wherein a message may comprise a category, further comprising automatically routing a message according to said message category.

29. A non-transitory computer-readable medium encoding instructions that, when executed by a data processing apparatus, cause the data processing apparatus to perform operations comprising:
communicating business transactions bi-directionally between user computers and a system server;
applying business logic to said business transaction and processing them according to a predefined workflow of a supply chain management system; and
sending and receiving messages triggered by said business transactions, according to predefined system rules.
